(19) United States
(12) Patent Application Publication
(10) Pub. No.: US 2026/0219632 A1
(43) Pub. Date: Jul. 30, 2026

(54) IMAGE FORMING APPARATUS

(71) Applicant: Yuta KAWASHIMA, Kanagawa (JP)

(72) Inventor: Yuta KAWASHIMA, Kanagawa (JP)

(73) Assignee: ETRIA CO., LTD., Yokohama (JP)

(21) Appl. No.: 19/441,193

(22) Filed: Jan. 6, 2026

(30) Foreign Application Priority Data
Jan. 29, 2025 (JP) 2025-012923

(51) Int. Cl. G03G 21/20; G03G 15/01

(52) U.S. Cl. CPC G03G 21/206; G03G 15/0189; G03G 2221/1648

(57) ABSTRACT

An image forming apparatus includes an apparatus body, a first station, second multiple stations, a first image former, second multiple image formers, a first air supply port, second multiple air supply ports, a first exhaust port, second multiple exhaust ports, an exhaust duct, and a sealer. The first image former is detachably attachable to the first station. The second multiple image formers are detachably attachable to the second multiple stations. The second multiple air supply ports supply air to the second multiple stations, and the supplied air is exhausted by the second multiple exhaust ports. The exhaust duct communicates with each of first exhaust port and the second multiple exhaust ports to exhaust the air outside the apparatus body. The sealer seals the second multiple exhaust ports when the second multiple image formers are detached. The sealer includes a restrictor to restrict an attachment of the second multiple image formers.

### CROSS-REFERENCE TO RELATED APPLICATION

This patent application is based on and claims priority pursuant to 35 U.S.C. § 119(a) to Japanese Patent Application No. 2025-012923, filed on Jan. 29, 2025, in the Japan Patent Office, the entire disclosure of which is hereby incorporated by reference herein.

### BACKGROUND

### Technical Field

The present disclosure relates to an image forming apparatus such as a copying machine, a printer, a facsimile machine, or a multifunction peripheral thereof.

### Related Art

In an image forming apparatus such as a copier or a printer, a technique has been proposed that can perform image forming (printing) in a state where only one image former is installed and the other image formers are not installed in a space where multiple image formers can be installed.

On the other hand, a technique in which only one imaging unit for black is installed in a space including stations in which four imaging units (image formers) can be installed is proposed. When printing is performed, a shielding member is installed between the space and a cooling fan. Air is exhausted from between the cooling fan and the shielding member through a ventilation passage disposed to communicate with a lower portion of the space.

Further, a technique of attaching and detaching an air suction and exhaust duct by increasing and decreasing multiple print engines (image formers) is proposed.

### SUMMARY

The present disclosure described herein provides an image forming apparatus that includes an apparatus body, a first station, second multiple stations, a first image former, second multiple image formers, a first air supply port, second multiple air supply ports, a first exhaust port, second multiple exhaust ports, an exhaust duct, and a sealer. The first station and the second multiple stations are in the apparatus body. The first image former is detachably attachable to the first station. The second multiple image formers are detachably attachable to the second multiple stations, respectively. The first air supply port supplies air to the first station. The second multiple air supply ports supply the air to the second multiple stations. The first exhaust port exhausts the air from the first station. The second multiple exhaust ports exhaust the air from the second multiple stations. The exhaust duct communicates with each of first exhaust port and the second multiple exhaust ports to exhaust the air outside the apparatus body. The sealer seals the second multiple exhaust ports when the second multiple image formers are detached from the second multiple stations, respectively. The sealer includes a restrictor to restrict an attachment of the second multiple image formers to the second multiple stations, respectively.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating an image former;

FIG. 3A is a top view of an image forming apparatus in a full specification state, illustrating flows of air therein;

FIG. 3B is a top view of the image forming apparatus of FIG. 3A in a specified specification state, illustrating flows of air therein;

FIG. 4A is a perspective view of an image forming apparatus in which an exterior cover is opened in a full specification state;

FIG. 4B is a perspective view of the image forming apparatus of FIG. 4A in which the exterior cover is opened in a specified specification state;

FIG. 5 is a top view of an image forming apparatus in a specified specification state according to a comparative example, illustrating flows of air therein;

FIG. 6 is a front view of an air supply passage;

FIG. 7 is a rear view of an exhaust passage;

FIG. 8A is a side view illustrating a state in which an exhaust port is opened in a full specification state;

FIG. 8B is a side view illustrating a state in which the exhaust port of FIG. 8A is closed by a sealer in a specified specification state;

FIG. 9A is a side view of a sealer;

FIG. 9B is a front view of the sealer of FIG. 9A;

FIGS. 10A, 10B, and 10C are diagrams illustrating an operation of attaching a sealer on the unused station;

FIG. 11A is a side view illustrating a state in which an image former is attached on a station in a full specification state;

FIG. 11B is a side view illustrating a state in which attachment of an image former is restricted in an unused station in a specified specification state;

FIG. 12A is a side view of a sealer as a first modification;

FIG. 12B is a front view of a sealer as the first modification; and

FIG. 13 is a top view illustrating a flow of air in a specified specification state in an image forming apparatus according to a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Identical or similar reference numerals are assigned to identical or equivalent components and a description of those components may be simplified or omitted. As used herein, the singular forms “a,” “an,” and “the” are intended to include the plural forms as well, unless the context clearly indicates otherwise.

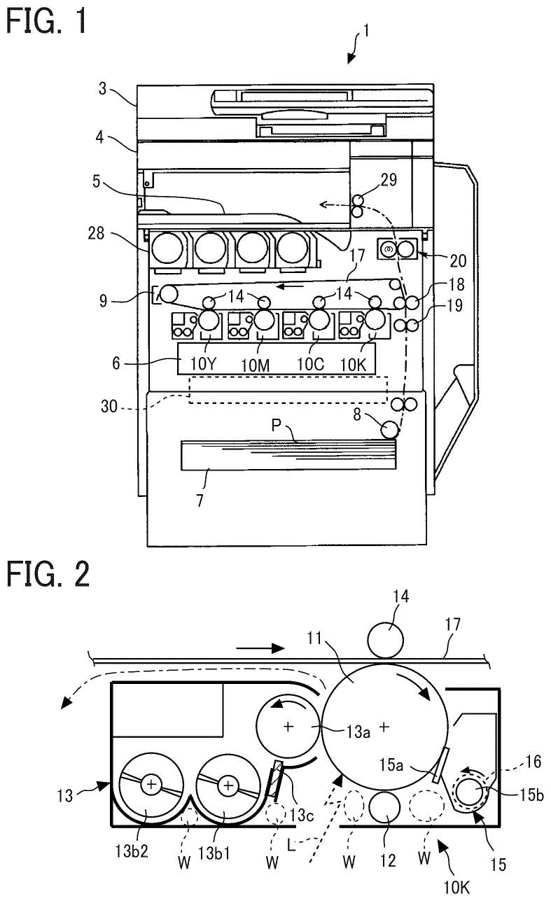

A description is given below of an overall configuration and operation of an image forming apparatus 1 with reference to FIG. 1. In FIG. 1, the image forming apparatus 1, which is illustrated as a color copier in the present embodiment, includes a document conveying device 3, a scanner 4 (document reading device), and a writing device 6 (exposure device). The document conveying device 3 conveys documents to the scanner 4. The scanner 4 scans the documents to read image data. The writing device 6 emits a laser beam based on input image data. The image forming apparatus 1 also includes a sheet feeder 7, image formers 10Y, 10M, 10C, and 10K, an intermediate transfer belt 17, and a secondary transfer roller 18. The sheet feeder 7 stores sheets P such as sheets of paper. The image formers 10Y, 10M, 10C, and 10K are image formers to form toner images of yellow, magenta, cyan, and black, respectively. The toner images of multiple colors are transferred and superimposed one on another onto the intermediate transfer belt 17. The secondary transfer roller 18 transfers the toner images on the intermediate transfer belt 17 onto the sheet P. The image forming apparatus 1 further includes a fixing device 20, toner containers 28, and a waste-toner collection container 30. The fixing device 20 fixes unfixed toner images on the sheet P. The toner containers 28 contain toners of respective colors to be supplied to developing devices 13 of the corresponding image formers 10Y, 10M, 10C, and 10K (process cartridges). Waste-toner is collected in the waste-toner collection container 30.

Each of the image formers 10Y, 10M, 10C, and 10K (process cartridges) includes a photoconductor drum 11 (serving as a photoconductor, which is an example of an image bearer), a charging device 12, the developing device 13, and a cleaning device 15, which are integrated as a single unit as illustrated in FIG. 2. Each of the image formers 10Y, 10M, 10C, and 10K, which is expendable, is replaced with a new one when depleted. Yellow, magenta, cyan, and black toner images are formed on the respective photoconductor drums 11 (serving as a photoconductor) in the image formers 10Y, 10M, 10C, and 10K.

A description is given below of operations of the image forming apparatus 1 to form a normal color toner image. Conveying rollers of the document conveying device 3 convey a document on a document table onto an exposure glass of the scanner 4. The scanner 4 optically scans the document on the exposure glass to read image data. The yellow, magenta, cyan, and black image data are transmitted to the writing device 6. The writing device 6 irradiates the photoconductor drums 11 of the corresponding image formers 10Y, 10M, 10C, and 10K with laser beams L (exposure light) based on the yellow, magenta, cyan, and black image data, respectively.

Meanwhile, the photoconductor drums 11 as four photoconductors rotate clockwise as illustrated in FIGS. 1 and 2. With reference to FIG. 2, the charging device 12 (a charging roller) uniformly charges a surface of the photoconductor drum 11 at a position opposite the photoconductor drum 11 (charging process). Thus, the surface of the photoconductor drum 11 is charged to a certain potential. Subsequently, the surface of the photoconductor drum 11 thus charged reaches a position where the surface of the photoconductor drum 11 is irradiated with the laser beam L. The writing device 6 emits, from a light source, the laser beams L for respective colors according to the image data of respective colors. The laser beams L are reflected by a polygon mirror and transmitted through multiple lenses. The laser beams L transmitted through the multiple lenses pass through different optical passages for the different color components of yellow, magenta, cyan, and black (an exposure process).

The laser beam L corresponding to the yellow image data is irradiated to the surface of the photoconductor drum 11 of the first image former 10Y from the left in FIG. 1, to form an electrostatic latent image for yellow thereon. Thus, an electrostatic latent image corresponding to the yellow image data is formed on the photoconductor drum 11 charged by the charging device 12. Similarly, the laser beam L corresponding to the magenta image data is irradiated to the surface of the photoconductor drum 11 of the second image former 10M from the left in FIG. 1, to form an electrostatic latent image for magenta thereon. The laser beam L corresponding to the cyan image data is irradiated to the surface of the photoconductor drum 11 of the third image former 10C from the left in FIG. 1, to form an electrostatic latent image for cyan thereon. The laser beam L corresponding to the black image data is irradiated to the surface of the photoconductor drum 11 of the fourth image former 10K from the left in FIG. 1, to form an electrostatic latent image for black thereon.

Then, the surface of the photoconductor drum 11 bearing the electrostatic latent image for each color reaches the position opposite the developing device 13 (see FIG. 2). The developing device 13 supplies toner of each color onto the surface of the photoconductor drum 11 and develops the electrostatic latent image on the photoconductor drum 11 into a toner image (development process). Subsequently, the surface of the photoconductor drum 11 after the development process reaches a position opposite the intermediate transfer belt 17 (intermediate transferor) as an image bearer. A primary transfer roller 14 is disposed at a position where the photoconductor drum 11 faces the intermediate transfer belt 17 and contacts an inner circumferential surface of the intermediate transfer belt 17. At the positions of the primary transfer rollers 14, the toner images on the photoconductor drums 11 are sequentially transferred and superimposed onto the intermediate transfer belt 17, forming a multicolor toner image thereon (primary transfer process).

After the primary transfer process, the surface of the photoconductor drum 11 reaches the position opposite the cleaning device 15 (see FIG. 2). The cleaning device 15 collects untransferred toner remaining on the photoconductor drum 11 (cleaning process). Then, the surface of the photoconductor drum 11 passes through a charge elimination device to complete a series of image forming processes performed on the photoconductor drum 11.

Meanwhile, the surface of the intermediate transfer belt 17, onto which the single-color toner images on the photoconductor drums 11 are transferred and superimposed, moves in a direction indicated by an arrow in FIG. 1 and reaches a position opposite a secondary transfer roller 18. The secondary transfer roller 18 secondarily transfers the multicolor toner image on the intermediate transfer belt 17 onto the sheet P (secondary transfer process). After the secondary transfer process, the surface of the intermediate transfer belt 17 reaches a position opposite an intermediate transfer belt cleaner 9 (a cleaning device for the intermediate transfer belt 17). The intermediate transfer belt cleaner 9 collects the untransferred toner on the intermediate transfer belt 17 to complete a series of transfer processes on the intermediate transfer belt 17.

The sheet P is conveyed from the sheet feeder 7 to the position of the secondary transfer roller 18 via, for example, a sheet conveyance guide and a registration roller pair 19. More specifically, a feed roller 8 feeds the sheet P from the sheet feeder 7 that stores a stack of sheets P, and the sheet P is then guided by the sheet conveyance guide to the registration roller pair 19. The sheet P that has reached the registration roller pair 19 is conveyed toward the position of the secondary transfer roller 18 at a timing at which the sheet P can receive the multicolor toner image on the intermediate transfer belt 17.

Subsequently, the sheet P, onto which the multicolor toner image is transferred, is conveyed to a fixing device 20. The fixing device 20 includes a fixing roller and a pressure roller pressing against each other. In a nip between the fixing roller and the pressure roller, the multicolor toner image is fixed on the sheet P. After the fixing process, a sheet ejection roller pair 29 ejects the sheet P as an output image to the exterior of a body of the image forming apparatus 1, and the ejected sheets P are stacked on a sheet ejection tray 5 to complete a series of image forming processes.

With reference to FIG. 2, a description is given below of the image formers 10Y, 10M, 10C, and 10K of the image forming apparatus 1 in detail. FIG. 2 is a diagram illustrating a configuration of the image former 10K for black. Each of the other three image formers 10Y, 10M, and 10C has substantially the same configuration as the image former 10K for black except for the color of toner used in the image forming process, and thus drawings and descriptions thereof are omitted to avoid redundancy.

As illustrated in FIG. 2, the image former 10K is a single unit that includes the photoconductor drum 11 as the image bearer, the charging device 12 to charge the photoconductor drum 11, the developing device 13 to develop an electrostatic latent image on the photoconductor drum 11, and the cleaning device 15 to remove untransferred toner from the photoconductor drum 11 in a casing of the image former 10K.

The photoconductor drum 11 is an organic photoconductor designed to be charged with a negative polarity and includes a photosensitive layer formed on a drum-shaped conductive support. The charging device 12 is a charging roller including a conductive core and an elastic layer of moderate resistivity overlaid on the outer circumference of the conductive core. A power supply applies a specified voltage to the charging device 12 (charging roller). Thus, the charging device 12 uniformly charges the surface of the photoconductor drum 11 facing the charging device 12.

The developing device 13 includes a developing roller 13a disposed opposite the photoconductor drum 11, a first conveying screw 13b1 disposed opposite the developing roller 13a, a second conveying screw 13b2 disposed opposite the first conveying screw 13b1 via a partition, and a doctor blade 13c disposed opposite the developing roller 13a. The developing roller 13a includes multiple magnets and a sleeve that rotates around the magnets. The magnets are stationary and generate magnetic poles around the circumferential surface of the developing roller 13a. The magnets generate multiple magnetic poles on the developing roller 13a (sleeve) to bear developer on the developing roller 13a. The developing device 13 stores two-component developer including carrier and toner.

The cleaning device 15 includes a cleaning blade 15a that contacts the photoconductor drum 11 and a conveying screw 15b (a conveyance tube 16) that conveys the untransferred toner collected in the cleaning device 15 toward a waste-toner conveying device as waste toner. For example, the cleaning blade 15a is made of rubber, such as urethane rubber, and contacts the surface of the photoconductor drum 11 at a specified angle with a specified pressure. With such a configuration, substances such as the untransferred toner adhering to the photoconductor drum 11 are mechanically scraped off and collected in the cleaning device 15. The untransferred toner collected in the cleaning device 15 is conveyed to the waste-toner conveying device via the conveyance tube 16 in which the conveying screw 15b is disposed and conveyed to the waste-toner collection container 30 by the waste-toner conveying device. The conveyed untransferred toner is collected in the waste-toner collection container 30 as the waste toner.

The image forming processes, described above, are described in further detail below with reference to FIG. 2. The developing roller 13a rotates in a direction (counterclockwise) indicated by an arrow in FIG. 2. In the developing device 13, as the first conveying screw 13b1 and the second conveying screw 13b2 arranged via the partition rotate, the developer is circulated in the longitudinal direction of the developing device 13, while being stirred and mixed with toner supplied from the toner container 28 by a toner supply device. The longitudinal direction of the developing device 13 is perpendicular to the plane on which FIG. 2 is illustrated.

Thus, the toner is triboelectrically charged and attracted to the carrier. The toner is borne on the developing roller 13a together with the carrier. The developer borne on the developing roller 13a reaches a position opposite the doctor blade 13c. The developer on the developing roller 13a is adjusted to an appropriate amount at the doctor blade 13c, and then is supplied to the position (developing region) facing the photoconductor drum 11. In the development area, the toner in the developer adheres to the electrostatic latent image formed on the surface of the photoconductor drum 11. The toner adheres to the electrostatic latent image (i.e., the toner image is formed) by a development electric field formed by a potential difference (i.e., a developing potential) between a latent image potential (i.e., an exposure potential) of an image area irradiated with the laser beam L and a development bias applied to the developing roller 13a. Subsequently, most of the toner attached to the photoconductor drum 11 in the development process is transferred onto the intermediate transfer belt 17. The untransferred toner remained on the surface of the photoconductor drum 11 is collected in the cleaning device 15 by the cleaning blade 15a.

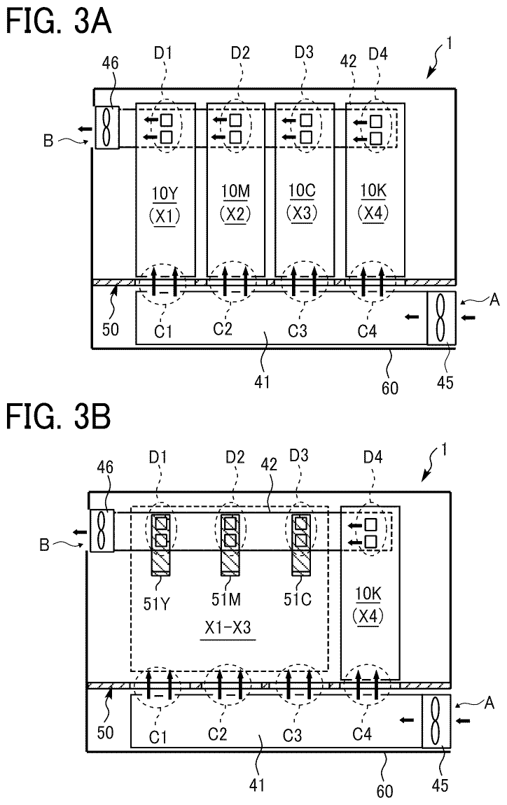

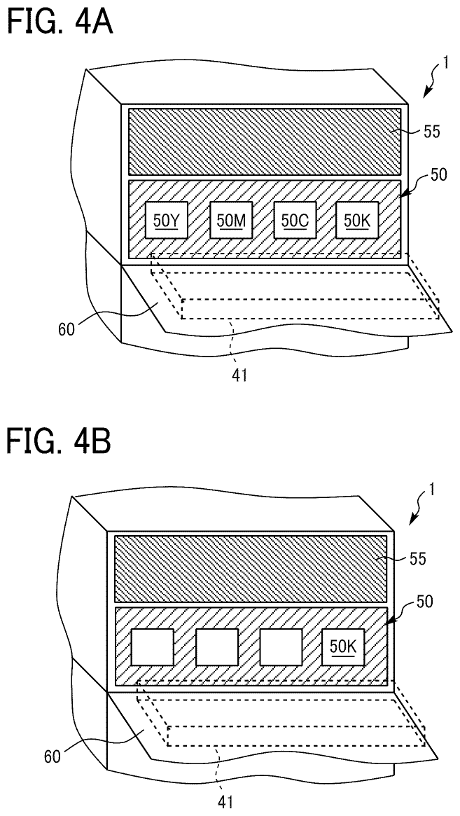

A description is given below of the configuration and operation of the image forming apparatus 1 according to the present embodiment in further detail. As described above with reference to FIG. 1, the multiple image formers 10Y, 10M, 10C, and 10K are removably installed in the image forming apparatus 1. Specifically, the multiple image formers are four image formers, that is, one image former 10K for black and three image formers 10Y, 10M, and 10C for colors. With reference to FIGS. 3A and 4A, the image forming apparatus 1 includes multiple stations X1, X2, X3, and X4 (installation sections) to which the multiple image formers 10Y, 10M, 10C, and 10K are removably installed, respectively. Specifically, the four image formers 10Y, 10M, 10C, and 10K are attached to or detached from the four stations X1, X2, X3, and X4, respectively. When the image formers 10Y, 10M, 10C, and 10K are not installed, the four stations X1, X2, X3, and X4 are spaces that are entirely open.

With reference to FIG. 3A, the image forming apparatus 1 includes a flow passage through which air (outside air) taken in from the outside through an inlet port A is caused to flow into a body of the image forming apparatus 1 and is exhausted to the outside of the body of the image forming apparatus 1 through an outlet port B. In other words, flow passages of air (gas) as indicated by black arrows in FIG. 3A are formed in the image forming apparatus 1. The flow passage is typically for cooling the image formers 10Y, 10M, 10C, and 10K (particularly, the developing device 13) and removing ozone generated by the charging process by the charging device 12 not to stay around the photoconductor drum 11.

The image forming apparatus 1 (flow passage) is provided with, for example, multiple (four) air supply ports C1, C2, C3, and C4, an air supply duct 41, an air supply fan 45, multiple (four) exhaust ports D1, D2, D3, and D4, an exhaust duct 42, an exhaust fan 46, and an ozone filter 47 (see FIG. 7). The multiple air supply ports C1, C2, C3, and C4 enable air supply to the multiple stations X1, X2, X3, and X4, respectively. In particular, referring to FIGS. 3A, 3B, and 6, in the present embodiment, two air supply ports (a first air supply port for the charging device 12 and a second air supply port for the developing device 13) are arranged horizontally in the left-and-right direction in FIGS. 3A and 3B for each of the four air supply ports C1, C2, C3, and C4. The air supply duct 41 is for allowing air taken in from the outside of the body of the image forming apparatus 1 via the inlet port A to flow toward the multiple air supply ports C1, C2, C3, and C4. Specifically, in the present embodiment, the air supply duct 41 has the four air supply ports C1, C2, C3, and C4 at positions facing the front sides (the lower sides in FIG. 3A, the front sides in the direction perpendicular to the plane on which FIG. 1 is illustrated, and the upstream sides of the four image formers 10Y, 10M, 10C, and 10K in an attachment direction) of the four image formers 10Y, 10M, 10C, and 10K, respectively. The air supply duct 41 is provided with the air supply fan 45 upstream (on the right side in FIG. 3A) from the multiple air supply ports C1, C2, C3, and C4 in the air flow direction. When the air supply fan 45 is driven, the outside air is actively taken into the air supply duct 41 through the inlet port A.

With reference to FIG. 4A, in the present embodiment, an exterior cover 60 (an opening-and-closing cover) that can open the inside of the image forming apparatus 1 is installed on the front side (the front side on which an operator such as a user performs typical operations) of the body of the image forming apparatus 1. When the exterior cover 60 is opened (in the state of FIGS. 4A and 4B), an inner cover 50 having insertion ports for attachment to and detachment from the image formers 10Y, 10M, 10C, and 10K is exposed. In the present embodiment, the air supply duct 41 (which is moved in accordance with an opening-and-closing operation of the exterior cover 60) is installed inside the exterior cover 60. When the exterior cover 60 is closed, the multiple air supply ports C1, C2, C3, and C4 of the air supply duct 41 communicate with (face) the openings of the image formers 10Y, 10M, 10C, and 10K via the insertion ports of the inner cover 50. Note that the positional relation of the full-specification inner cover 50, the air supply duct 41, and the stations X1, X2, X3, and X4 is not limited to the positional relation illustrated in FIG. 3A.

With reference to FIGS. 3A and 7, the multiple exhaust ports D1, D2, D3, and D4 enable exhaust from the image formers 10Y, 10M, 10C, and 10K installed in the multiple stations X1, X2, X3, and X4, respectively. The exhaust duct 42 causes the air exhausted toward (flowed into) the multiple exhaust ports D1, D2, D3, and D4 to flow toward the outside of the body of the image forming apparatus 1. In the present embodiment, the four exhaust ports D1, D2, D3, and D4 are formed on the rear side of the four image formers 10Y, 10M, 10C, and 10K (on the upper side in FIG. 3A, on the rear side in the direction perpendicular to the plane on which FIG. 1 is illustrated, and on the downstream side in the attachment direction of the image formers 10Y, 10M, 10C, and 10K).

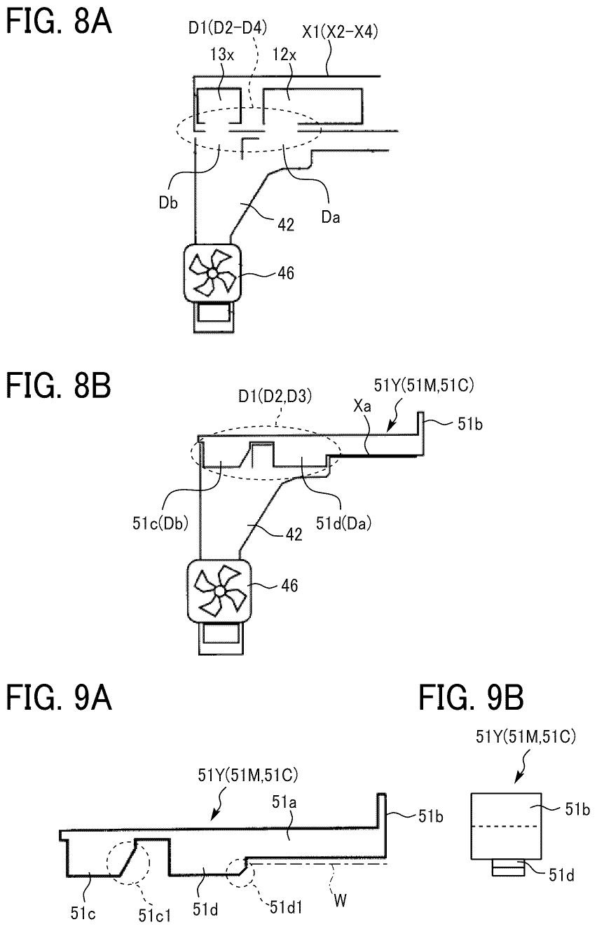

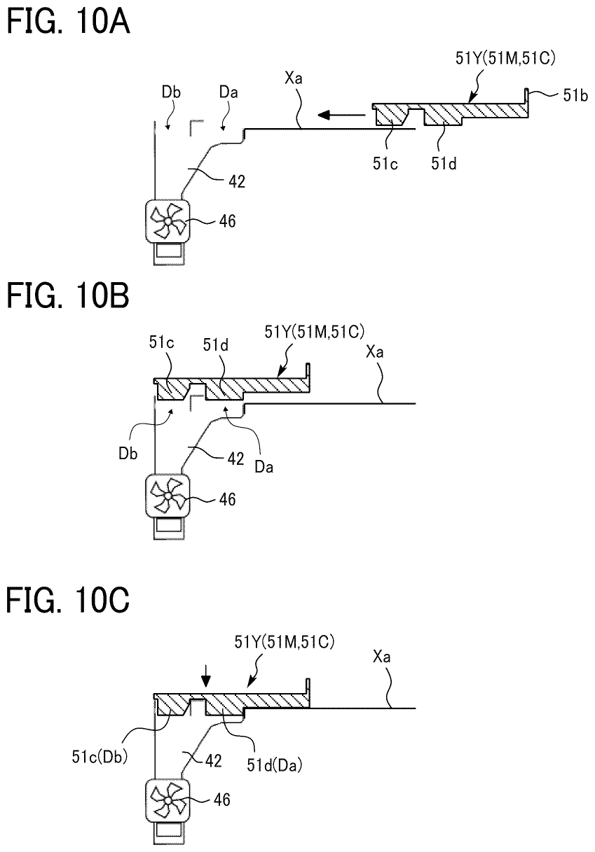

In particular, with reference to FIGS. 3A, 3B, 7, and 8A, in the present embodiment, two exhaust ports (a first exhaust port Da for the charging device 12 and a second exhaust port Db for the developing device 13) are disposed in parallel in the vertical direction in FIGS. 3A and 3B (attachment direction of the image former) in each of the four exhaust ports D1, D2, D3, and D4. The multiple exhaust ports D1, D2, D3, and D4 of the exhaust duct 42 communicate with (face) the openings of the image formers 10Y, 10M, 10C, and 10K (a charger frame 12x and a developing unit frame 13x illustrated in FIG. 8A) via openings formed in bottom surfaces Xa (see FIGS. 10A, 10B, and 10C) of the multiple stations X1, X2, X3, and X4. In the body of the image forming apparatus 1, the exhaust duct 42 is made of a resinous material, and is fixed to a metallic frame (housing) forming multiple stations X1, X2, X3, and X4 by, for example, screwing. The multiple openings formed in the stations X1, X2, X3, and X4 communicate with the multiple exhaust ports D1, D2, D3, and D4 formed in the exhaust duct 42, and are united with the multiple exhaust ports D1, D2, D3, and D4 in appearance (function as exhaust ports of the body of the image forming apparatus 1). An elastic seal member made of foamed polyurethane is adhered to the edge of each of the multiple exhaust ports D1, D2, D3, and D4 formed in the exhaust duct 42, so that air does not leak from between the exhaust duct 42 and each of the stations X1, X2, X3, and X4. The openings of the image formers 10Y, 10M, 10C, and 10K (the charger frame 12x and the developing unit frame 13x) communicate with the exhaust ports D1, D2, D3, and D4 formed in this manner, so that exhaust passages are formed.

More specifically, the multiple image formers 10Y, 10M, 10C, and 10K are attached to the multiple stations X1, X2, X3, and X4 in a substantially horizontal direction with the side on which the air supply ports C1, C2, C3, and C4 are formed as the upstream side in the attachment direction and the side on which the exhaust ports D1, D2, D3, and D4 are formed as the downstream side in the attachment direction. The exhaust duct 42 is installed downstream from the multiple stations X1, X2, X3, and X4 in the attachment direction (downstream from the image formers 10Y, 10M, 10C, and 10K in the attachment direction). The exhaust duct 42 is provided with the exhaust fan 46 on the downstream side of the multiple exhaust ports D1, D2, D3, and D4 in the air-flow direction (including air containing ozone), and the ozone filter 47 (see FIG. 7) for collecting ozone in the air on the downstream side of the exhaust fan 46 in the air-flow direction. The exhaust fan 46 is driven, so that the air in the exhaust duct 42 is actively caused to flow toward the outlet port B. The first exhaust port Da enables air to be exhausted from the charging device 12. The exhaust port Db enables air to be exhausted from the developing device 13. The exhaust passages are formed in the charger frame 12x and the developing unit frame 13x illustrated in FIG. 8A such that the first exhaust port Da and the second exhaust port Db are arranged side by side in the attachment direction (the up-and-down direction in FIGS. 3A and 3B, the direction perpendicular to the plane on which FIG. 7 is illustrated, and the left-and-right direction in FIGS. 8A and 8B). The exhaust ports D1, D2, D3, and D4 (the first exhaust port Da and the second exhaust port Db) of the exhaust ducts 42 are opened upward to communicate with the openings formed in the bottom surfaces Xa of the stations X1, X2, X3, and X4. As described above, the multiple openings formed in the stations X1, X2, X3, and X4 communicate with the multiple exhaust ports D1, D2, D3, and D4 (the first exhaust port Da and the second exhaust port Db) formed in the exhaust duct 42, and are united with the multiple exhaust ports D1, D2, D3, and D4 in appearance (function as exhaust ports of the body of the image forming apparatus 1). The positional relation between the exhaust duct 42 and the stations X1, X2, X3, and X4 is not limited to the positional relation illustrated in FIG. 3A.

In the present embodiment, the air that has flowed into the stations X1, X2, X3, and X4 from the air supply ports D1, D2, D3, and D4 passes through the inside of the image formers 10Y, 10M, 10C, and 10K (typically, spaces W surrounded by the dashed lines in FIG. 2) installed in the stations X1, X2, X3, and X4, and is flowed into the exhaust ports D1, D2, D3, and D4, respectively. In other words, the air is released from the front side to the rear side in the image formers 10Y, 10M, 10C, and 10K. Such a configuration can enhance cooling performance of the image formers 10Y, 10M, 10C, and 10K (particularly, the developing device 13). Thus, an inconvenience that the fluidity of the toner in the developer stored in the developing device 13 is reduced due to heat, and an inconvenience that the toner is fixed in the vicinity of the bearings of the first conveying screws 13b1 and the second conveying screw 13b2 are reduced. Ozone generated by the charging process by the charging device 12 is removed not to stay around the photoconductor drum 11, so that deterioration of the photoconductor drum 11 and occurrence of abnormal images due to ozone can be reduced.

The image forming apparatus 1 according to the present embodiment can perform image formation (printing) in a “first state” in which all of the multiple (four) image formers 10Y, 10M, 10C, and 10K are installed in the multiple (four) stations X1, X2, X3, and X4 as illustrated in FIGS. 1, 3A, and 4A, or in a “second state” in which the use station X4, in which the image former 10K is installed, and the unused stations X1, X2, and X3, in which the image formers 10Y, 10M, and 10C are not installed, are present among the multiple (four) stations X1, X2, X3, and X4 as illustrated in FIGS. 3B and 4B. The image forming apparatus 1 can switch the two states described above. In the following description, the “first state” described above is referred to as a “full specification state”, and the “second state” described above is referred to as a “specified specification state”, as appropriate. In the present embodiment, the “specified specification state (second state)” is a state in which monochrome image formation (monochrome printing) can be performed using only the image former 10K for black.

Accordingly, the image forming apparatus 1 according to the present embodiment can be used by a user as a full-color image forming apparatus using four colors (Y, M, C, and K) or as a monochrome image forming apparatus using only black. Such a configuration can reduce the cost required for design and manufacturing compared to a case where a full-color image forming apparatus and a monochrome image forming apparatus are separately manufactured. Even when a user desires to change the image forming apparatus from a full-color image forming apparatus to a monochrome image forming apparatus or from a monochrome image forming apparatus to a full-color image forming apparatus, such a configuration can meet the desire of the user without much cost.

In the present embodiment, as illustrated in FIG. 3A, when image formation is performed in the “full specification state” as the first state (when the image forming apparatus 1 is used as a full-color image forming apparatus) , the air exhausted from the multiple stations X1, X2, X3, and X4 is exhausted through all of the multiple exhaust ports D1, D2, D3, and D4. On the other hand, as illustrated in FIG. 3B, when image formation is performed in the “specified specification state” (when the image forming apparatus 1 is used as the monochrome image forming apparatus), air is exhausted from the use station X4 (the image former 10K for black) via the exhaust port D4 corresponding to the use station X4 among the multiple (four) exhaust ports D1, D2, D3, and D4. Sealers 51Y, 51M, and 51C are installed in the other exhaust ports D1, D2, and D3 so that air is not exhausted from the unused stations X1, X2, and X3 (the image formers 10Y, 10M, and 10C for yellow, magenta, and cyan).

In other words, the sealers 51Y, 51M, and 51C are not installed in the body of the image forming apparatus 1 (the unused stations X1, X2, and X3) when image formation is performed in the “full specification state (first state)”, and seal so that air is not exhausted from the exhaust ports D1, D2, and D3 corresponding to the unused stations X1, X2, and X3 among the multiple exhaust ports D1, D2, D3, and D4 when image formation is performed in the “specified specification state (second state)”. With reference to FIGS. 3B and 8B, the sealers 51Y, 51M, and 51C are formed to close the exhaust ports D1, D2, and D3 corresponding to the unused stations X1, X2, and X3. In the present embodiment, multiple (three) unused stations X1, X2, and X3 are present in the specified specification state (in the second state). The sealers 51Y, 51M, and 51C are formed to close all of the multiple exhaust ports D1, D2, and D3 corresponding to the multiple (three) unused stations X1, X2, and X3 in the exhaust duct 42, respectively. In other words, in the specified specification state, three sealers 51Y, 51M, and 51C corresponding to the three exhaust ports D1, D2, and D3 are installed in the image forming apparatus 1. As described above, the sealers 51Y, 51M, and 51C are not installed in the image forming apparatus 1 in the full specification state (in the first state). However, the state of “not being installed in the image forming apparatus” is defined to include not only a state of not being completely built in the image forming apparatus 1, but also a state of being stored (built in) in a storage space installed inside the image forming apparatus 1 as long as the sealers 51Y, 51M, and 51C are not installed to close the exhaust ports D1, D2, and D3 of the unused stations X1, X2, and X3.

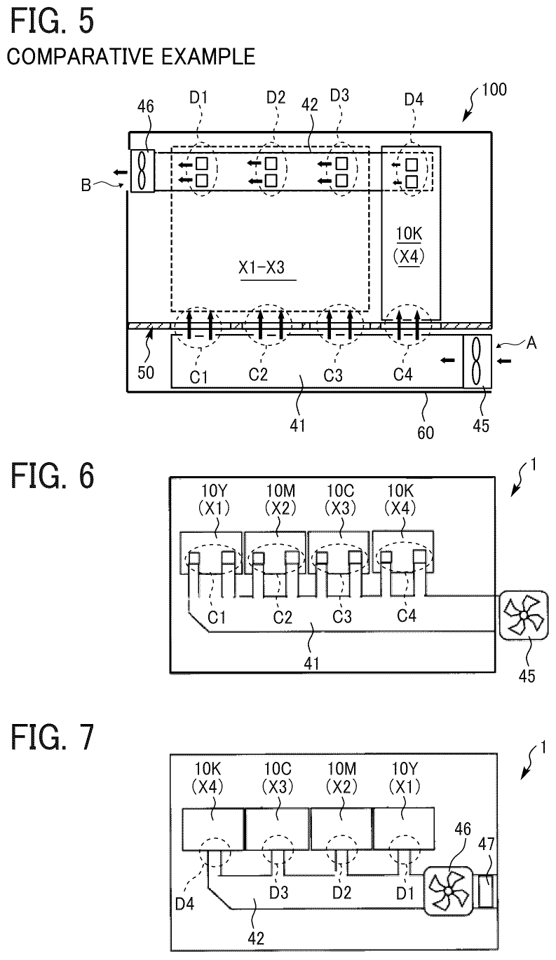

As described above, in the present embodiment, the air is not exhausted from the unused stations X1, X2, and X3 (color image formers 10Y, 10M, and 10C) in the specified specification state, so that the desired airflow for the use station can be efficiently formed both when the image formation is performed in the full specification state (first state) and when the image formation is performed in the specified specification state (second state). Specifically, as illustrated in FIG. 3B, in the specified specification state, a flow passage through which air passes from the front side to the rear side is formed only in the image former 10K for black (use station X4), that is, only a suction air flow from the use exhaust port D4 is formed. Such a flow passage is not formed in the other unused stations X1, X2, and X3 (a suction air flow from the unused exhaust ports D1, D2, and D3 is not formed). As a result, the fluidity of air in the use station X4 is maintained well, compared to a case where such a flow passage (suction air flow) is also formed in the unused stations X1, X2, and X3 as in an image forming apparatus 100 illustrated in FIG. 5 as a comparative example. Thus, the cooling performance and the ozone removal performance for the image former 10K for black (use station X4).

In the present embodiment, as illustrated in FIGS. 3A and 3B, all of the multiple air supply ports C1, C2, C3, and C4 are opened in both the full specification state (first state) and the specified specification state (second state). In the specified specification state (second state), the air is not exhausted from the unused exhaust ports D1, D2, and D3, thus preventing an inconvenience that the fluidity of the air with respect to the image former 10K for black (use station X4) is decreased in the specified specification state compared to the full specification state and the cooling performance or the ozone removing performance is also decreased. In the present embodiment, a passage (not communicating with the use station X4) for exhausting the air flowing into the unused stations X1, X2, and X3 (in a state where the exhaust ports D1, D2, and D3 are sealed by the sealers 51Y, 51M, and 51C, respectively) via the air supply ports C1, C2, and C3 in the specified specification state to the outside of the image forming apparatus 1 can be installed separately from the exhaust duct 42.

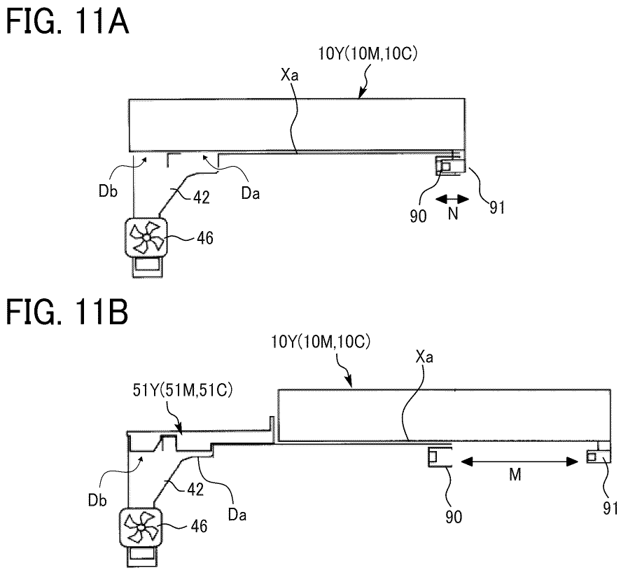

As illustrated in FIGS. 8B, 9A, and 9B, in the present embodiment, each of the sealers 51Y, 51M, and 51C includes restrictors 51b that limit the attachment of the image formers 10Y, 10M, and 10C to the unused stations X1, X2, and X3. Specifically, as illustrated in FIGS. 9A and 9B, each of the sealers 51Y, 51M, and 51C includes a surface portion 51a (main portion), projections 51c and 51d, and the restrictor 51b. The surface portion 51a is formed to be in surface contact with the bottom surfaces Xa of the stations X1, X2, and X3 (the surface on which the image formers 10Y, 10M, and 10C slide when the image formers 10Y, 10M, and 10C are attached to and detached from the stations X1, X2, and X3). The surface portion 51a is formed in a substantially rectangular parallelepiped shape to extend in the attachment direction (the up-and-down direction in FIG. 3B, and the left-and-right direction in FIGS. 8B and 9A). The surface portion 51a is provided with an adhesive (or a double-sided tape) on a portion (a surface W indicated by a dashed line in FIG. 9A) that comes into surface contact with the bottom surface Xa, and thus, the portion serves as an adhesive surface W and is adhered to the bottom surface Xa. The projections 51c and 51d are portions that protrude downward from the surface portion 51a and are fitted to the exhaust ports D1, D2, and D3. One projection 51c is fitted to the second exhaust port Db for developing, and the other projection 51d is fitted to the first exhaust port Da for charging. The projections 51c and 51d are arranged in parallel in the attachment direction in accordance with the arrangement of the first exhaust port Da and the second exhaust port Db. In the present embodiment, the bottom surfaces (flat surfaces) of the two projections 51c and 51d are set so that the projection amounts downward thereof are equal to each other with reference to the adhesive surface W (the surface indicated by the dashed line in FIG. 9A) of the surface portion 51a. Such a configuration facilitates the operation of sliding the sealers 51Y, 51M, and 51C on the bottom surface Xa, which is described later with reference to FIGS. 10A, 10B, and 10C. The restrictor 51b is a portion that rises upward from the surface portion 51a at an upstream end in the attachment direction (an upstream end in the attachment direction of the image formers 10Y, 10M, and 10C with respect to the stations X1, X2, and X3, and a right end in FIG. 9A), and is a portion for preventing an inconvenience that the unused image formers 10Y, 10M, and 10C are set in the unused stations X1, X2, and X3 in the specified specification state. The restrictor 51b is a wall extending in a direction perpendicular to the attachment direction, has a relatively high strength, and extends upward from the surface portion 51a to a sufficiently high position. The unused image formers 10Y, 10M, and 10C are not completely set in the stations X1, X2, and X3 as illustrated in FIG. 11A. Even if the unused image formers 10Y, 10M, and 10C are attempted to be set in the unused stations X1, X2, and X3 as illustrated in FIG. 11B, the unused image formers 10Y, 10M, and 10C interfere with the restrictors 51b of the sealers 51Y, 51M, and 51C, and are not set in the unused stations X1, X2, and X3. In a state where the image formers 10Y, 10M, and 10C are not completely set, the exterior cover 60 (see FIGS. 4A and 4B) is not closed so that an operator who is about to close the exterior cover 60 notices the state (an erroneous setting). In the present embodiment, the sealers 51Y, 51M, and 51C are bonded to the stations X1, X2, and X3, so that an inconvenience that the sealers 51Y, 51M, and 51C are detached due to aerodynamic force in the opposite direction from the exhaust ports D1, D2, and D3, and an inconvenience that the sealers are detached due to an impact when the sealers 51Y, 51M, and 51C are hit against the image formers 10Y, 10M, and 10C, which are erroneously set, can be prevented.

The sealers 51Y, 51M, and 51C having a configuration as described above may be formed of a metallic material or a resinous material. When the sealers 51Y, 51M, and 51C are formed of a metallic material, the strength when the image formers 10Y, 10M, and 10C are erroneously set and contact with each other can be enhanced, and the sealers 51Y, 51M, and 51C can function as a fire barrier to the exhaust duct 42. On the other hand, when the sealers 51Y, 51M, and 51C are formed of a resinous material, the sealers 51Y, 51M, and 51C can be molded even in a relatively complicated shape, and the visibility of the sealers 51Y, 51M, and 51C can be enhanced by toning.

In the present embodiment, the restrictors 51b of the sealers 51Y, 51M, and 51C are also used as handles (portions to be gripped by an operator) when the sealers 51Y, 51M, and 51C are attached to the stations X1, X2, and X3. Specifically, as illustrated in FIGS. 10A, 10B, and 10C, when an operator manually installs the sealers 51Y, 51M, and 51C on the stations X1, X2, and X3 (unused stations), first, as illustrated in FIG. 10A, the sealers 51Y, 51M, and 51C are moved in a substantially horizontal direction to slide the projections 51c and 51d on the bottom surfaces Xa of the stations X1, X2, and X3. Then, as illustrated in FIGS. 10B and 10C, the sealers 51Y, 51M, and 51C are moved downward to fit the projections 51c and 51d into the first exhaust port Da and the second exhaust port Db (exhaust port connectors ports D1, D2, and D3), and the surface portion 51a is adhered to the bottom surface Xa. When the image forming apparatus 1 is switched from the full specification state to the specified specification state, a worker can install the sealers 51Y, 51M, and 51C in the stations X1, X2, and X3 in a manufacturing plant, or a service person or a user can install the sealers 51Y, 51M, and 51C in the stations X1, X2, and X3 in the market. When the image forming apparatus 1 is switched from the specified specification state to the full specification state, the operation of detaching the sealers 51Y, 51M, and 51C from the stations X1, X2, and X3 is performed in the reverse procedure to the procedure described with reference to FIGS. 10A, 10B, and 10C. In such a case, an operation that a jig having a scraper shape is inserted between the bottom surfaces Xa and the sealers 51Y, 51M, and 51C to release the adhesion of the sealers 51Y, 51M, and 51C is added in order to release the adhesion of the sealers 51Y, 51M, and 51C from the bottom surfaces Xa. Forming a tapered portion inclined downward from above toward the downstream side at the lower end of the end of the surface portion 51a on the upstream side in the attachment direction is preferable in order to increase the workability of such release of the adhesion (in order to facilitate the insertion of the jig).

With reference to FIG. 9A, the projections 51c and 51d of the sealers 51Y, 51M, and 51C have tapered portions 51c1 and 51d1 inclined downward from the upstream side toward the downstream side with respect to the direction (attachment direction) in which the image formers 10Y, 10M, and 10C are installed on the stations X1, X2, and X3. As described above, the projections 51c and 51d are provided with the tapered portions 51c1 and 51d1, so that the process of fitting the projections 51c and 51d into the first exhaust port Da and the second exhaust port Db, which has been described above with reference to FIGS. 10B and 10C, is smoothly performed.

With reference to FIGS. 11A and 11B, in the present embodiment, the stations X1, X2, X3, and X4 are provided with connector-type sensors 90 as detectors that can detect whether the corresponding image formers 10Y, 10M, 10C, and 10K are attached. The connector-type sensor 90 (detector) has a fitting portion. The fitting portion is fitted with a fitted portion 91 installed in each of the image formers 10Y, 10M, 10C, and 10K to detect a state in which each of the image formers 10Y, 10M, 10C, and 10K is installed in corresponding one of the stations X1, X2, X3, and X4. The detection of the presence of the setting of the image formers 10Y, 10M, 10C, and 10K by the connector-type sensor 90 is performed in all of the four stations X1, X2, X3, and X4 in the full specification state. Regarding a station in which the image former 10Y, 10M, 10C, or 10K is not set, a message that the image former is not set at the position of the station is displayed on an operation display panel.

In the image forming apparatus 1 in the specified specification state, the restrictors 51b of the sealers 51Y, 51M, and 51C restrict the installation of the image formers 10Y, 10M, and 10C to the unused stations X1, X2, and X3 on the upstream side (right in FIG. 11B) in the attachment direction from the position where the image formers 10Y, 10M, and 10C can be detected by the connector-type sensor 90 (detector) in the unused stations X1, X2, and X3. In other words, in the specified specification state, when the image formers 10Y, 10M, and 10C are erroneously set in the unused stations X1, X2, and X3, the image formers 10Y, 10M, and 10C interfere with the restrictors 51b before the image formers 10Y, 10M, and 10C that are erroneously set are detected by the connector-type sensors 90 (detector). With such a configuration, in the specified specification state, an inconvenience that the unused image formers 10Y, 10M, and 10C are detected by the connector-type sensors 90 (detector) is prevented.

More specifically, when a length in the attachment direction required for fitting the fitted portion 91 of each of the image formers 10Y, 10M, and 10C to the fitting portion of the connector-type sensor 90 in order to detect the installment of each of the image formers 10Y, 10M, and 10C is N as illustrated in FIG. 11A, as illustrated in FIG. 11B, a clearance M in the attachment direction of the fitted portion 91 with respect to the fitting portion of the connector-type sensor 90 when the installment of each of the image formers 10Y, 10M, and 10C is restricted by the restrictor 51b in each of the unused stations X1, X2, and X3 is set to be larger than N (M>N). In the present embodiment, the relation between M and N is set to satisfy M≥4×N so that the above-described effect is exhibited with a margin. In the present embodiment, the connector-type sensor 90 is used as a detector that detects whether the image formers 10Y, 10M, 10C, and 10K are installed on the stations X1, X2, X3, and X4. However, the detector is not limited thereto, and for example, a non-contact-type optical sensor or an electrical contact-type contact sensor may be used as the detector. In such a case, when the image formers 10Y, 10M, and 10C are erroneously set in the unused stations X1, X2, and X3 in the specified specification state, the image formers 10Y, 10M, and 10C interfere with the restrictor 51b before the erroneously set image formers 10Y, 10M, and 10C are detected by the detector, and thus it is possible to prevent a problem in which the unused image formers 10Y, 10M, and 10C are detected by the detector.

### First Modification

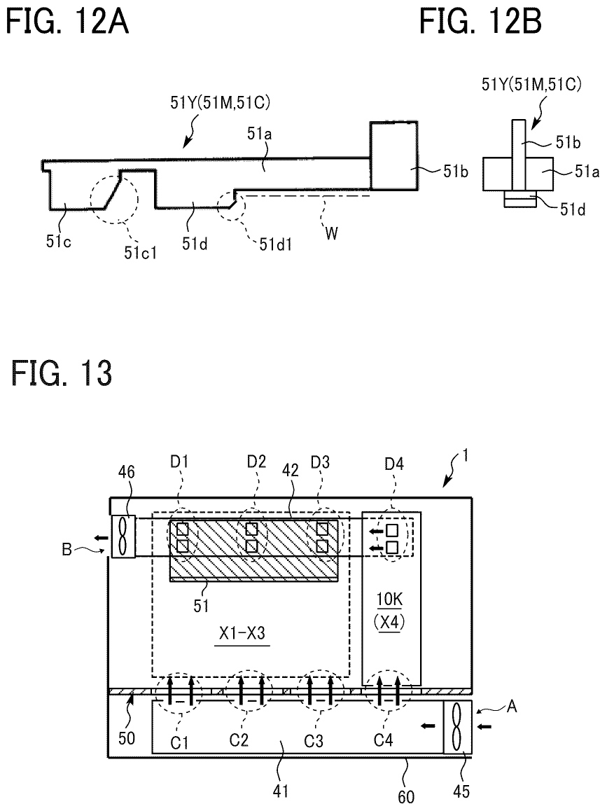

As illustrated in FIG. 12A, in the sealers 51Y, 51M, and 51C in a first modification, the restrictor 51b is formed to rise upward from the surface portion 51a at the upstream end of the surface portion 51a in the attachment direction, but is formed in a thin plate shape to protrude upstream in the attachment direction at the upstream end of the surface portion 51a in the attachment direction. The restrictor 51b has a width (thickness) in the width direction (in a direction perpendicular to the attachment direction, a direction perpendicular to the plane on which FIG. 12A is illustrated, and a left-and-right direction of FIG. 12B) smaller than a width (thickness) of the surface portion 51a in the width direction. The restrictor 51b formed in this manner is easy to handle (easy to grip) as a handle for a worker, and thus, the assemblability of the sealers 51Y, 51M, and 51C to the unused stations X1, X2, and X3 is enhanced. Even in the case where the sealers 51Y, 51M, and 51C are formed as in the first modification, even when image formation is performed in the full specification state (first state) and even when image formation is performed in the specified specification state (second state), erroneous setting of the image formers 10Y, 10M, and 10C to the unused stations X1, X2, and X3 is efficiently prevented while efficiently forming a desired airflow in the use stations X1, X2, X3, and X4 (or the station X4 in the specified specification state).

### Second Modification

As illustrated in FIG. 13, in an image forming apparatus 1 according to a second modification, multiple (three) unused stations X1, X2, and X3 are installed in the specified specification state, similarly to the image forming apparatus 1 illustrated in FIG. 3B. In the second modification, the sealer 51 is not installed in each of the multiple unused stations X1, X2, and X3 as illustrated in FIG. 3B, but one sealer 51 is collectively installed in the multiple unused stations X1, X2, and X3. Specifically, the sealer 51 in the second modification is formed to collectively close all of the multiple exhaust ports D1, D2, and D3 corresponding to the multiple unused stations X1, X2, and X3 in the exhaust duct 42. In other words, the three sealers 51Y, 51M, and 51C illustrated in FIG. 3B are not divided but united as one sealer 51. Accordingly, the sealer 51 has all of the surface portion 51a, the projections 51c and 51d, and the restrictor 51b, which are formed on the three sealers 51Y, 51M, and 51C illustrated in FIG. 3B. As in the second modification, even when the sealer 51 is formed, even when image formation is performed in the full specification state (first state) and even when image formation is performed in the specified specification state (second state), erroneous setting of the image formers 10Y, 10M, and 10C to the unused stations X1, X2, and X3 can be efficiently prevented while efficiently forming a desired airflow in the use stations X1, X2, X3, and X4 (or the station X4 in the specified specification state).

As described above, the image forming apparatus 1 according to the present embodiment includes the multiple stations X1, X2, X3, and X4, the multiple air supply ports C1, C2, C3, and C4, the multiple exhaust ports D1, D2, D3, and D4, and the exhaust duct 42. The multiple stations X1, X2, X3, and X4 include the multiple image formers 10Y, 10M, 10C, and 10K attachable to and detachable from the multiple stations X1, X2, X3, and X4. The multiple air supply ports C1, C2, C3, and C4 enable air supply to the multiple stations X1, X2, X3, and X4. The multiple exhaust ports D1, D2, D3, and D4 enable air exhaust from the multiple stations X1, X2, X3, and X4. The exhaust duct 42 causes air exhausted to the multiple exhaust ports D1, D2, D3, and D4 to flow toward outside of the outside of the body of the image forming apparatus 1. The image forming apparatus 1 includes the sealers 51Y, 51M, and 51C that seal the exhaust ports D1, D2, and D3 so that air is not exhausted from the exhaust ports D1, D2, and D3 corresponding to the unused stations X1, X2, and X3 among the multiple exhaust ports D1, D2, D3, and D4 when image formation is performed in a state (second state) in which the use station X4 in which the image former 10K is installed and the unused stations X1, X2, X3 in which the image formers 10Y, 10M, and 10C are not installed are present among the multiple stations X1, X2, X3, and X4. The sealers 51Y, 51M, and 51C include the restrictors 51b that restrict the attachment of the image formers 10Y, 10M, and 10C to the unused stations X1, X2, and X3. As a result, when image formation is performed in a state (second state) in which the use station X4 and the unused stations X1, X2, and X3 are present, erroneous setting of the image formers 10Y, 10M, and 10C to the unused stations X1, X2, and X3 can be efficiently prevented while efficiently forming a desired airflow in the use station X4.

In the image forming apparatus 1 according to the present embodiment, the image formers 10Y, 10M, 10C, and 10K of four colors (Y, M, C, and K) are installed in the full specification state and one image former 10K is installed in the specified specification state. However, the number of image formers installed in the full specification state and the number of image formers installed in the specified specification state are not limited to those in the present embodiment. For example, the number of image formers installed in the full specification state may be five, which includes four for full color (Y, M, C, and K) and additional one for clear color or infrared. Further, the number of image formers installed in the specified specification state may be three for color (Y, M, and C). In the present disclosure, the shapes of the air supply duct 41 and the exhaust duct 42, the positions of the air supply ports C1, C2, C3, and C4, and the positions of the exhaust ports D1, D2, D3, and D4 are not limited to those in the present embodiment. In the present embodiment, the image forming apparatus 1 includes the image former 10Y for yellow, the image former 10M for magenta, the image former 10C for cyan, and the image former 10K for black arranged in this order from the upstream side in the traveling direction of the intermediate transfer belt 17. However, the order of arrangement is not limited to the order of the present embodiment and may be another order of arrangement. In the present embodiment, each of the four exhaust ports D1, D2, D3, and D4 includes the first exhaust port Da for charging and the second exhaust port Db for developing separately. However, each of the four exhaust ports D1, D2, D3, and D4 may not include two separate exhaust port, or may be include three or more separate exhaust ports. In this case, the exhaust port may be used only for development, only for charging, or for other purposes, or may be used in combination of two or three or more of these purposes. Such cases can also provide substantially the same or similar effects as the effects described above.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

Aspects of the present disclosure may be, for example, a combination of the first to fourteenth aspects as follows.

### First Aspect

An image forming apparatus (e.g., the image forming apparatus 1) includes multiple stations (e.g., the stations X1, X2, X3, and X4), multiple air supply ports (e.g., the air supply ports C1, C2, C3, and C4), multiple exhaust ports (e.g., the exhaust ports D1, D2, D3, and D4), an exhaust duct (e.g., the exhaust duct 42), and a sealer (e.g., the sealers 51Y, 51M, and 51C). Multiple image formers (e.g., the image formers 10Y, 10M, 10C, and 10K) are attachable to and detachable from the multiple stations. The multiple air supply ports enable air supply to the multiple stations. The multiple exhaust ports enable exhaust from the multiple stations. The exhaust duct flows air exhausted to the multiple exhaust ports toward an outside of a body of the image forming apparatus. When image formation is performed in a state where a use station (e.g., the use station X4) in which one of the multiple image formers is installed and an unused station (e.g., the unused stations X1, X2, and X3) in which none of the multiple image formers is installed are present, the sealer seals an exhaust port corresponding to the unused station among the multiple exhaust ports to prevent air exhaust. The sealer has a restrictor (e.g., the restrictor 51b) to restrict attachment of the multiple image formers to the unused station.

### Second Aspect

In the image forming apparatus (e.g., the image forming apparatus 1) according to the first aspect, the sealer (e.g., the sealers 51Y, 51M, and 51C) is formed to close the exhaust port (e.g., the exhaust ports D1, D2, and D3) corresponding to the unused station (e.g., the unused stations X1, X2, and X3).

### Third Aspect

In the image forming apparatus (e.g., the image forming apparatus 1) according to the first or second aspect, multiple unused stations (e.g., the unused stations X1, X2, and X3) are installed. The sealer (e.g., the sealers 51Y, 51M, and 51C) is formed to collectively close all of the multiple exhaust ports (e.g., the exhaust ports D1, D2, and D3) corresponding to the multiple unused stations in the exhaust duct (e.g., the exhaust duct 42).

### Fourth Aspect

In the image forming apparatus (e.g., the image forming apparatus 1) according to any one of the first to third aspects, the sealer (e.g., the sealers 51Y, 51M, and 51C) includes a surface portion (e.g., the surface portion 51a), a projection (e.g., the projections 51c and 51d), and the restrictor (e.g., the restrictor 51b). The surface portion is formed to contact a bottom surface of each of the multiple stations (e.g., the stations X1, X2, X3, and X4). The projection protrudes downward from the surface portion to fit into each of the multiple exhaust ports (e.g., the exhaust ports D1, D2, D3, and D4). The restrictor rises upward from the surface portion at an end on an upstream side in an attachment direction of each of the multiple image formers (e.g., the image formers 10Y, 10M, 10C, and 10K) with respect to each of the multiple stations.

### Fifth Aspect

In the image forming apparatus (e.g., the image forming apparatus 1) according to the fourth aspect, the restrictor (e.g., the restrictor 51b) is also used as a handle when the sealer (e.g., the sealers 51Y, 51M, and 51C) is attached to each of the multiple stations (e.g., the stations X1, X2, and X3).

### Sixth Aspect

In the image forming apparatus (e.g., the image forming apparatus 1) according to the fourth or fifth aspect, the projection (e.g., the projections 51c and 51d) has a tapered portion (e.g., the tapered portions 51c1 and 51d1) that is inclined downward from an upstream side toward a downstream side with respect to a direction in which each of the multiple image formers (e.g., the image formers 10Y, 10M, 10C, and 10K) is attached on each of the multiple stations (e.g., the stations X1, X2, X3, and X4).

### Seventh Aspect

In the image forming apparatus (e.g., the image forming apparatus 1) according to any one of the fourth to sixth aspects, the surface portion (e.g., the surface portion 51a) has an adhesive surface at a portion that contacts the bottom surface in a surface contact manner. The surface portion is adhered to the bottom surface when the projection (e.g., the projections 51c and 51d) is fitted into each of the multiple exhaust ports (e.g., the exhaust ports D1, D2, D3, and D4).

### Eighth Aspect

In the image forming apparatus (e.g., the image forming apparatus 1) according to any one of the fourth to seventh aspects, a width of the restrictor (e.g., the restrictor 51b) in a width direction orthogonal to the attachment direction is shorter than a width of the surface portion (e.g., the surface portion 51a) in the width direction.

### Ninth Aspect

In the image forming apparatus (e.g., the image forming apparatus 1) according to any one of the first to eighth aspects, the multiple image formers (e.g., the image formers 10Y, 10M, 10C, and 10K) are attached in a substantially horizontal direction with respect to the multiple stations (e.g., the stations X1, X2, X3, and X4), with a side on which each of the multiple air supply ports (e.g., the air supply ports C1, C2, C3, and C4) is formed being an upstream side in an attachment direction and a side on which each of the multiple exhaust ports (e.g., the exhaust ports D1, D2, D3, and D4) is formed being a downstream side in the attachment direction. The exhaust duct (e.g., the exhaust duct 42) is installed on the downstream side in the attachment direction with respect to the multiple stations.

### Tenth Aspect

In the image forming apparatus (e.g., the image forming apparatus 1) according to any one of the first to ninth aspects, each of the multiple stations (e.g., the stations X1, X2, X3, and X4) includes a detector (e.g., the connector-type sensor 90) that detects whether the corresponding image former is attached. The restrictor (e.g., the restrictor 51b) of the sealer (e.g., the sealers 51Y, 51M, and 51C) restricts attachment of the image former (e.g., the image formers 10Y, 10M, and 10C) to the unused station (e.g., the unused stations X1, X2, and X3) on an upstream side in the attachment direction from a position where the image former can be detected by the detector in the unused station.

### Eleventh Aspect

In the image forming apparatus (e.g., the image forming apparatus 1) according to the tenth aspect, the detector (e.g., the connector-type sensor 90) includes a fitting portion that detects a state in which each of the multiple image formers (e.g., the image formers 10Y, 10M, 10C, and 10K) is attached by fitting a fitted portion (e.g., the fitted portion 91) disposed in each of the multiple image formers. When a length in the attachment direction required for fitting the fitted portion to the fitting portion in order to detect attachment of the image former is N, a separation distance of the fitted portion from the fitting portion in the attachment direction when attachment of the image former is restricted by the restrictor (e.g., the restrictor 51b) in the unused station (e.g., the unused stations X1, X2, and X3) is larger than N.

### Twelfth Aspect

In the image forming apparatus (e.g., the image forming apparatus 1) according to any one of the first to eleventh aspects, each of the multiple image formers (e.g., the image formers 10Y, 10M, 10C, and 10K) include a charging device (e.g., the charging device 12) that charges a surface of a photoconductor (e.g., the photoconductor drum 11) and a developing device (e.g., the developing device 13) that develops a latent image formed on the surface of the photoconductor. Each of the multiple exhaust ports (e.g., the exhaust ports D1, D2, D3, and D4) include a first exhaust port (e.g., the first exhaust port Da) that enables exhaust from the charging device and a second exhaust port (e.g., the second exhaust port Db) that enables exhaust from the developing device.

### Thirteenth Aspect

In the image forming apparatus (e.g., the image forming apparatus 1) according to any one of the first to twelfth aspects, the exhaust duct (e.g., the exhaust duct 42) includes an exhaust fan (e.g., the exhaust fan 46) on a downstream side of the multiple exhaust ports (e.g., the exhaust ports D1, D2, D3, and D4) in an airflow direction.

### Fourteenth Aspect

In the image forming apparatus (e.g., the image forming apparatus 1) according to any one of the first to thirteenth aspects, the multiple image formers (e.g., the image formers 10Y, 10M, 10C, and 10K) include an image former for black and three image formers for colors. A state where the use station and the unuse station are present is the state where monochrome image formation can be performed using only the image former (e.g., the image former 10K) for black.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus comprising:
an apparatus body;
a first station in the apparatus body;
second multiple stations in the apparatus body;
a first image former detachably attachable to the first station;
second multiple image formers detachably attachable to the second multiple stations, respectively;
a first air supply port to supply air to the first station;
second multiple air supply ports to supply the air to the second multiple stations;
first exhaust port to exhaust the air from the first station;
second multiple exhaust ports to exhaust the air from the second multiple stations;
an exhaust duct communicating with each of first exhaust port and the second multiple exhaust ports to exhaust the air outside the apparatus body; and
a sealer to seal the second multiple exhaust ports when the second multiple image formers are detached from the second multiple stations, respectively,
wherein the sealer includes a restrictor to restrict an attachment of the second multiple image formers to the second multiple stations, respectively.

2. The image forming apparatus according to claim 1, further comprising multiple sealers including the sealer,
wherein the multiple sealers closes the second multiple exhaust ports, respectively.

3. The image forming apparatus according to claim 1,
wherein the sealer includes a single sealer to close the second multiple exhaust ports simultaneously.

4. The image forming apparatus according to claim 1,
wherein the second multiple image formers are attached to the second multiple stations, respectively, in an attachment direction,
the sealer includes:
a surface portion to be in surface contacting with a bottom surface of at least one of the second multiple stations;
a projection protruding downward from the surface portion to fit into at least one of the second multiple exhaust ports; and
the restrictor rising upward from the surface portion at an upstream end of the sealer in the attachment direction.

5. The image forming apparatus according to claim 4,
wherein the restrictor of the sealer rises upward as a handle to attach the sealer to the second multiple stations.

6. The image forming apparatus according to claim 4,
wherein the projection has a tapered portion inclined downward from an upstream side toward a downstream side in the attachment direction.

7. The image forming apparatus according to claim 4,
wherein the surface portion has an adhesive surface at a portion to be in surface contacting with the bottom surface, and
the adhesive surface of the surface portion is adhered to the bottom surface when the projection is fitted into at least one of the second multiple exhaust ports.

8. The image forming apparatus according to claim 4,
wherein the surface portion has a first width in a width direction orthogonal to the attachment direction, and
the restrictor has a second width smaller than the first width in the width direction.

9. The image forming apparatus according to claim 4,
wherein the second multiple image formers have:
the second multiple air supply ports at an upstream side of the second multiple image formers in the attachment direction; and
the second multiple exhaust ports at a downstream side of the second multiple image formers in the attachment direction,
the second multiple image formers attached to the second multiple stations are arranged in a horizontal direction, and
the exhaust duct is disposed at the downstream side of the second multiple stations in the attachment direction.

10. The image forming apparatus according to claim 9,
wherein the second multiple stations includes multiple detectors to detect the attachment of the second multiple image formers to the second multiple stations, respectively, and
the sealer at a sealing position to seal the second multiple exhaust ports includes the restrictor to place the second multiple image formers at a restriction position upstream of a detection position, in the attachment direction, where the multiple detectors detect the second multiple image formers, respectively.

11. The image forming apparatus according to claim 10,
wherein each of the second multiple image formers include a fitted portion,
each of the multiple detectors include a fitting portion to fit into the fitted portion when the second multiple image formers are attached to the second multiple stations, respectively,
a first length is formed between the fitted portion and the fitting portion when the second multiple image formers are disposed at the detection position,
a second length is formed between the fitted portion and the fitting portion when the second multiple image formers are disposed at the restriction position, and
the second length is larger than the first length.

12. The image forming apparatus according to claim 1,
wherein each of first image former and the second multiple image formers includes:
a charging device to charge a surface of a photoconductor; and
a developing device to develop a latent image formed on the surface of the photoconductor, and
each of the first exhaust port and the second multiple exhaust ports includes:
a first exhaust port to exhaust air from the charging device; and
a second exhaust port to exhaust air from the developing device.

13. The image forming apparatus according to claim 1,
wherein the exhaust duct includes an exhaust fan on a downstream side of the second multiple exhaust ports in an airflow direction.

14. The image forming apparatus according to claim 1,
wherein the first image former forms a black image,
when the second multiple image formers are detached from the second multiple stations, and
when the sealer seals the second multiple exhaust ports.
